(19) United States
(12) Patent Application Publication
(10) Pub. No.: US 2016/0358189 A1
(43) Pub. Date: Dec. 8, 2016

(54) DATA ACQUISITION AND ANALYTICS REPORTING

(71) Applicant: Resun8, Reno, NV (US)

(72) Inventors: Matthew Richard Furry, Reno, NV (US); Steve William Schroeder, Reno, NV (US); Matthew Kaala Anthony Brown, Maple Valley, WA (US); Richard Vincent Liotta, Incline Village, NV (US)

(73) Assignee: Resun8, Reno, NV (US)

(21) Appl. No.: 14/733,493

(22) Filed: Jun. 8, 2015

(51) Int. Cl. G06Q 30/02; H04W 4/02

(52) U.S. Cl. CPC G06Q 30/0201; H04W 4/023; H04W 84/18

(57) ABSTRACT

Provided is a data acquisition and analytics reporting system that may be utilized for an event driven marketing industry. The system includes one or more universally unique identifier transceivers, one or more universally unique identifier data collectors, and at least one data accumulator. The universally unique identifier transceiver receives data from a wearable device brought into a communication range of the universally unique identifier transceiver. The wearable device is associated with a target entity at a live event. The universally unique identifier data collector receives a set of the data from the universally unique identifier transceiver and another set of data from at least another universally unique identifier transceiver. The data accumulator obtains the set of the data and the other set of data from the universally unique identifier data collector and at least one other universally unique identifier data collector at a time selected to mitigate an amount of network traffic at the live event.

### BACKGROUND

At various live events, such as trade shows or music festivals, there may be thousands of attendees, or even hundreds of thousands of attendees. During the event, each attendee walks around the event and travels their unique path. Each attendee may interact with vendors at various event booths and might be interested in the products offered by some of the vendors. However, at the end of the event, those attendees leave and the vendors might not have contact information for the attendee. Thus, the vendors (and associated product manufacturers) do not have an accurate understanding of the level of interest. Further, since there might not be contact information for the attendees, the vendors are not able to successfully promote or market their products in a targeted manner after the event.

Further, although interest may be peaked during the event, the customer might not be willing to take the time to follow-up after the event, and might lose interest in the product. Thus, without direct, targeted marketing after the event, the vendor might lose a business opportunity and the revenue that otherwise would be generated by the event exposure.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

An aspect relates to a system that includes a universally unique identifier transceiver that receives data from a wearable device based on the wearable device being brought into a communication range of the universally unique identifier transceiver. The wearable device is associated with a target entity at a live event. The system also includes a universally unique identifier data collector that receives a set of the data from the universally unique identifier transceiver and another set of data from at least another universally unique identifier transceiver. The universally unique identifier transceiver and the other universally unique identifier transceiver are predefined for the universally unique identifier data collector. Also included in the system is a data accumulator that obtains the set of the data and the other set of data from the universally unique identifier data collector and at least one other universally unique identifier data collector at a time selected to mitigate an amount of network traffic at the live event. The set of the data and the other set of data are included in a strategic marketing campaign based on the live event.

Another aspect relates to a method that includes receiving, at a first device, data from a universally unique identifier associated with an attendee at an event comprising detecting the universally unique identifier is within a wireless communications range of the first device. The method also includes outputting, by the first device to a mobile application associated with the universally unique identifier, dynamic electronic information associated with a current location of the universally unique identifier. The first device conveys the received data to a second device at a time selected to mitigate an amount of wireless data traffic within the event. The second device temporarily stores the received data. The method also includes transmitting, by the second device, the temporarily stored data to a third device at a time selected to mitigate another amount of the wireless data traffic within the event. Further, the method includes communicating, by the third device, at least a set of the stored data to an external database.

Another aspect relates to a computer-readable storage device storing executable instructions that, in response to execution, cause a system comprising a processor to perform operations. The operations includes determining a location of an attendee at a live event and outputting information related to a display associated with the location of the attendee based on a request for the information. The operations also include compiling information indicative of the attendee and the request with other information indicative of other attendees and other requests and dynamically creating at least one report based on an analysis of the complied information.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings in which:

FIG. 1 illustrates an example, non-limiting system for data acquisition and analytics reporting, according to an aspect;

FIG. 2 illustrates an example, non-limiting method for a data acquisition system, according to an aspect;

FIG. 3 illustrates an example, non-limiting representation of a high-level architecture, according to an aspect;

FIG. 4 illustrates a user-portion of the non-limiting system of FIG. 1 for data acquisition and analytics reporting, according to an aspect;

FIG. 5 illustrates a universally unique identifier transceiver that may be included in a mesh network portion of the non-limiting system of FIG. 1 for data acquisition and analytics reporting, according to an aspect;

FIG. 6 illustrates a universally unique identifier data collector that may be included in a database portion of the non-limiting system of FIG. 1 for data acquisition and analytics reporting, according to an aspect;

FIG. 7 illustrates an example, non-limiting method for deploying a data acquisition and analytics reporting system, according to an aspect;

FIG. 8 illustrates an example, non-limiting computer-readable medium or computer-readable device including processor-executable instructions configured to embody one or more of the aspects set forth herein; and

FIG. 9 illustrates an example, non-limiting computing environment where one or more of the aspects set forth herein are implemented, according to one or more embodiments.

### DETAILED DESCRIPTION

The innovation is now described with reference to the drawings. In the following description, for purposes of explanation, numerous specific details are set forth in order to provide a thorough understanding of the subject innovation. It may be evident, however, that the innovation may be practiced without these specific details. In other instances, well-known structures and devices are shown in block diagram form in order to facilitate describing the innovation.

The various aspects disclosed herein relate to a data acquisition and analytics reporting system, which may be utilized for an event driven marketing industry, for example. The various aspects may provide location-aware information to an event participant and may allow the event participant to provide feedback and/or request follow-up information. The one or more aspects may also passively track the activities of the event participant during the event, allowing for substantial analytics, reporting, and targeted marketing to be created from the gathered data.

It should be understood that any type of universally unique identifier (UUID) might be utilized with the disclosed aspects. A UUID is a bit value (e.g., a 128-bit value), where the meaning of each bit is defined by several variants. Any type of technology may be utilized for the UUID, such as, but not limited to, a beacon, a global positioning system, a radio frequency, a modulation format, such as LoRa™, and so on.

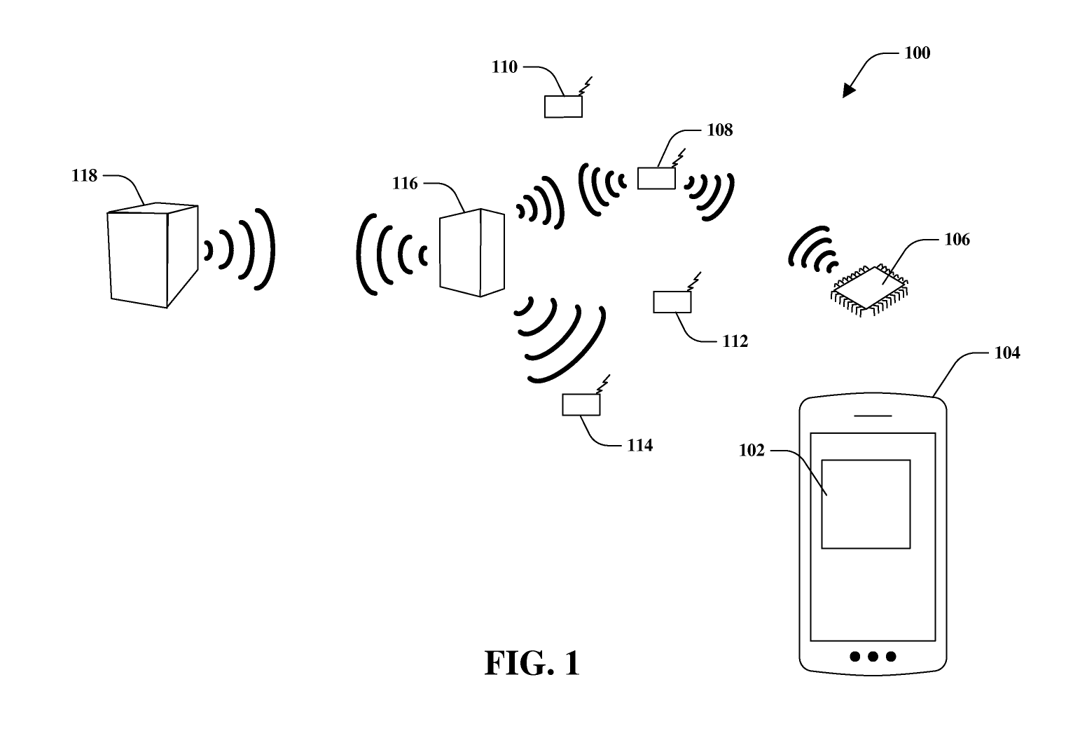

FIG. 1 illustrates an example, non-limiting system 100 for data acquisition and analytics reporting, according to an aspect. The system 100 may be placed at an event or venue, such as an automobile show, a boat show, a museum, a store, a historical site, a trade show, a music festival, and so forth. The system 100 includes a combination of components that operate in conjunction to track movement of a target entity at the venue. The target entity may be a person at the event, such as a customer, a potential customer, a potential client, or a client.

At least a subset of the components may be configured as a mesh network. Each component (e.g., node) in the mesh network may relay data for the network. Further, each component cooperates in the distribution of data in the network. According to an implementation, the components may relay messages (e.g., information) using a routing technique. Thus, the messages are propagated along a path by hopping from component to component (e.g., node to node) until the message reaches its destination.

The various aspects disclosed herein may provide nearly one hundred percent passive tracking and active coverage. Thus, at any event, the attendees may be tracked, a determination may be made as to which vendors (booths or products) where visited, as well as the interests of the attendee. At the end of the event, the marketing department of the various vendors may direct their marketing techniques appropriately based on the gathered information. For example, one or more reports may be provided that contain data related to the gathered information. For example, the reports may indicate how many people visited various booths, how often a particular person visited a booth, wherein the person requested content related to the booth, which people are potential active sales leads, and so forth. The reports may be tailored for specific vendors such that competitors are not able to view the reports for each other.

In a specific example, a report may indicate that a particular participant attended every day of the event. Further, on each day the participant visited the booth for a certain vendor. In addition, the report may indicate that the participant spent specific time at a particular location of the booth, which may indicate a preference for the item displayed at or near that particular location (e.g., visited a car manufacturer's event location and always stopped at a particular sports car). Thus, an email or other type of communication may be sent to the participant after the event to follow up on the marketing lead.

Further, although multiple components are utilized, the various aspects have a small footprint. In addition, the architecture is scalable such that any number of components may be added and/or removed without significant impact (if any) on other components. One unit (or one component) may be configured to provide significant location-based data. Further, there is no dependency on external systems. Instead, each component may be self-powered, which mitigates the need for multiple power drops at the venue. Thus, there is no additional infrastructure needed during the event. In addition, the component cost is moderate, thus, the disclosed aspects are not cost prohibitive.

In one example, the venue may be a car show and the target entity is a person that attends the car show. As the person (target entity) moves around the car show, the various components of the system 100 monitor the person's movements. As the user stops at an exhibit at the car show, information about that exhibit may be dynamically output to the user, such as through the user's mobile device. The information may be output automatically or based on a request from the user for the information. Thus, the interaction may be customer-initiated according to one or more aspects.

Additionally or alternatively, information may be gathered about the user and an inference may be made as the user's interests about one or more exhibits. Based on this information, marketing material and/or other information may be distributed to the user after the event. For example, the user may stop at an exhibit for a particular automobile and, based on that information and information associated with the user (e.g., user demographics), an advertisement may be sent to the user after the event (e.g., through a direct mailing effort, through email or another format of electronic communication, and so forth).

As illustrated, the system 100 may include at least one mobile application 102 that executes on at least one mobile device 104. Each attendee at the event may have their own mobile device; therefore, there may be multitudes of mobile devices executing respective mobile applications at the event. According to an implementation, the application 102 may be included in an operations management system. Further, the application 102 may be configured to determine information to output to the user and may include a web management portal. The application 102 may output information based on a current location of the user. Thus, the user does not need to request specific information, but simply requests information associated with their current location.

The application 102 may be installed on the mobile device 104 by the user prior to the user attending the event. However, according to some implementations, the user may decide to participate in the data acquisition program provided by exhibitors at the event and may install the application 102 on their device while at the event (e.g., during a registration process or at another time). According to some implementations, the user may be provided an incentive to participate in the data acquisition program.

It is noted that in accordance with one or more implementations described in this disclosure, users may opt-out of providing personal information, demographic information, location information, proprietary information, sensitive information, or the like in connection with data gathering aspects. Moreover, one or more implementations described herein may provide for anonymizing collected, received, and/or transmitted data. Further, a user may opt-out of providing information at any time, regardless of whether the user previously opted-in to providing the information.

A mobile device may also be called, and may contain some or all of the functionality of a system, subscriber unit, subscriber station, mobile station, mobile, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WLL) station, a personal digital assistant (PDA), a laptop, a handheld communication device, a handheld computing device, a netbook, a tablet, a satellite radio, a data card, a wireless modem card and/or another processing device for communicating over a wireless system.

Also included in the system 100 is at least one wearable device, such as a wearable UUID 106. The wearable UUID 106 may utilize various radio frequencies to communicate. For example, the wearable UUID 106 may utilize an ultra-high frequency (UHF) for communication. According to an implementation, the wearable UUID 106 is utilized as a reverse UUID (e.g., the attendee is a UUID) and broadcasts its information. A UUID that uniquely identifies the wearable UUID 106 may be programmed into the mobile application 102 to synchronize the wearable UUID 106 and the mobile application 102. In such a manner, the wearable UUID 106 may broadcast its location information and content related to that location may be presented to the user through the mobile device 104.

A user of the mobile device 104 may place the wearable UUID 106 on his clothing, in his pocket, in a bag, or at another location, such that the wearable UUID 106 and the mobile device 104 are at substantially the same location as the user. Although the wearable UUID 106 is illustrated as a chip, the wearable UUID 106 may in another format. For example, the wearable UUID 106 may be placed in a badge, wherein participants of the venue are distributed badges upon registration and entry at the venue.

According to an implementation, the wearable UUID 106 may include a radio frequency identification (RFID) chip. For example, the RFID chip may be a passive RFID chip or an active RFID chip. An active RFID chip includes a transmitter and a power source (e.g., a battery). The power source operates the RFID chip's circuitry and broadcasts a signal to a reader. A passive RFID tag does not have a power source. Instead, the passive RFID tag draws power from an RFID reader as the passive RFID tag is within range of the RFID reader. The RFID reader transmits electromagnetic waves that induce a current in the passive RFID tag's antenna.

As a target entity travels about the venue, the wearable UUID 106 may be read by one or more UUID transceiver devices that are placed within the venue. Thus, the UUID transceiver devices may operate, at least in part, as an RFID reader. Continuing the example of an automobile show, an automobile manufacturer may have an exhibit and may place one or more UUID transceivers at various locations within the exhibit. For example, each automobile on display may be co-located with a UUID transceiver device (e.g., attached to the automobile or placed near the automobile). By having more than one UUID transceiver, the location of the target entity may be better ascertained and a determination may be made as to what portion of the exhibit is of interested to the target entity. Further, the UUID transceivers may be self-powered and, therefore, do not need to be installed near power drops located at the venue.

Illustrated in FIG. 1 is a set of four universally unique identifier (UUID) transceivers, labeled as a first UUID transceiver 108, a second UUID transceiver 110, a third UUID transceiver 112, and a fourth UUID transceiver 114. In the example of FIG. 1, the first UUID transceiver 108 is communicating with the wearable badge 106. Thus, the wearable badge 106 is communicating information and the first UUID transceiver 108 is communicating information. Although four UUID transceivers are illustrated and described, it should be understood that fewer or more UUID transceivers might be located at a venue. Each set of UUID transceivers located at the venue may be associated with a different exhibit (e.g., vendor, manufacturer, and so forth).

Also included is a universally unique identifier (UUID) data collector 116, which may include a content sever. Further, the UUID data collector 116 may communicate with other UUID data collectors located at the venue. The UUID data collectors at the venue may communication over a Wi-Fi network with each other (e.g., a mesh network). However, communication outside the venue (e.g., over the Internet) is not need by the UUID data collectors. Additionally, the UUID data collectors may be self-powered. Therefore, the UUID data collectors are self-sufficient and do not need power drops or internet drops installed at the venue.

Each set of UUID transceivers may communicate with at least one UUID data collector, referred to as a UUID data collector device 116. For example, a single UUID data collector device may be located at a vendor's booth and a multitude of UUID transceivers may be also located at the vendor's booth. Thus, the relationship between the UUID data collector and the UUID transceivers may be a one-to-many relationship.

For example, the illustrated UUID data collector 116 may be within wireless data range of the first UUID transceiver 108, the second UUID transceiver 110, the third UUID transceiver 112, and the fourth UUID transceiver 114. The UUID data collector 116 may operate as a wireless access point for the UUID transceivers. An access point may be also be called, and may contain some or all of the functionality of, a base station, Node B, or another network entity.

A data accumulator 118 may be configured to communicate with multiple UUID data collectors. Thus, at a venue there may be a single data accumulator 118 that communicates with a multitude of UUID data collectors in a one-to-many relationship. The data accumulator 118 may comprise a fixed IP address and may be Wi-Fi enabled. Further, the data accumulator 118 may be pre-loaded with content, as further discussed herein.

The data accumulator 118 may be configured to convey the gathered information to the “cloud.” According to an implementation, the data accumulator 118 may have a wired or a wireless data link and may communicate directly with external servers (e.g., over the Internet). According to some implementations, the data accumulator 118 may include, or may be operatively connected to, a secondary router configured to send the information to the cloud. By using a secondary router, the data accumulator 118 does not communicate directly over the Internet, which provides additional security features. According to some implementations, the information is transmitted to a node that comprises a SQL database.

The gathered information may be processed by a system, such as a business intelligence system. The business intelligence system may include various databases, such as a transactional database, an analytics database, and a data warehouse database. Further, the business intelligence system may include a reporting portal. After the event, the business intelligence system analyzes the received data and generates reports that may be utilized for targeted marketing efforts.

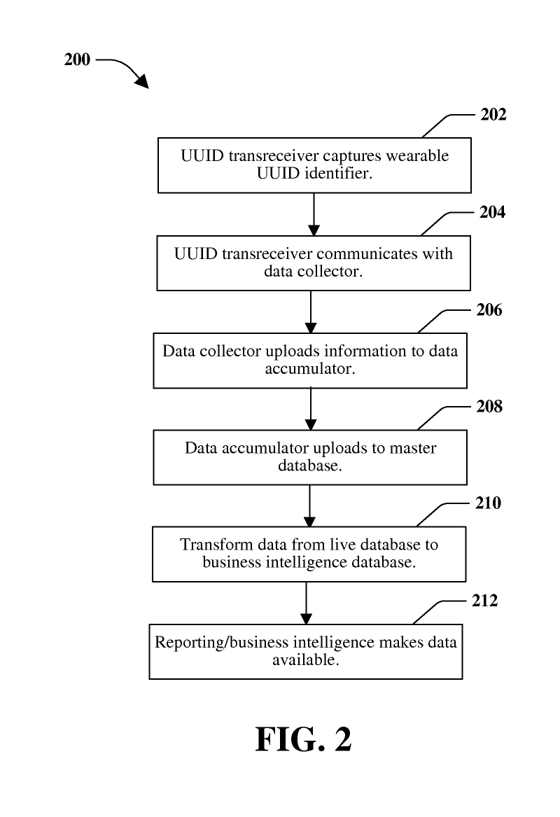

FIG. 2 illustrates an example, non-limiting method 200 for a data acquisition system, according to an aspect. Methods that may be implemented in accordance with the disclosed subject matter will be better appreciated with reference to various flow charts. While, for purposes of simplicity of explanation, the methods are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the disclosed methods. It is to be appreciated that the functionality associated with the blocks may be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods might alternatively be represented as a series of interrelated states or events, such as in a state diagram.

The method 200 starts, at 202, when a UUID transreceiver captures data from a wearable UUID identifier. For example, as a customer (e.g., potential target) walks around an event, the customer may wear a UUID (e.g., the UUID 106 of FIG. 1). The UUID and UUID transreceiver (e.g., the first transreceiver 108 of FIG. 1) may communicate when the UUID is brought into range of the UUID transreceiver (e.g., when the customer walks into the area around the UUID transreceiver. The UUID provides various information to the UUID transreceiver including data indicative of a user, demographic information, contact information, and other information provided by the user or information gathered, or inferred by, the system.

At 204, the UUID transreceiver communicates with a data collector (e.g., the data collector 116 of FIG. 1). The communicated data may include the information received from the UUID. Further, the communicated data may include an identity of the UUID transreceiver, an identity of the transreceiver, and/or other information associated with the transreceiver. The communicated data may also include an amount of time (and when) the UUID was in communication with the transceiver (e.g., how long the user was at the booth location), whether the user requested information, information related to other UUIDs (and other participants) that were in the vicinity of the user, and so forth.

The data collector may write data to a local database, where the data is stored for further processing. For example, the data collector may retain the communicated data until the data is uploaded, at 206, to a data accumulator (e.g., the data accumulator 118 of FIG. 1). For example, to mitigate the amount of network traffic in the venue, the data collector may retain the collected data until after the event is closed for the day (e.g., at 2:00 a.m.). Further, each data collector may have a specific time to convey its information. For example, a first data collector may communicate with a data accumulator at 2:00 a.m., a second data collector may communicate with the data accumulator at 2:15 a.m., a third data collector may communicate with the data accumulator at 2:20 a.m., and so forth. Further, each set of data collectors may communicate with their respective data accumulators at substantially the same time, or at different times. For example, if the first data collector communicates with its data accumulator at 2:00 a.m., another first data collector may communicate with its data accumulator at 2:05 a.m. or at a completely different time (e.g., 4:25 a.m.).

The data accumulator may collect and temporarily store information from multiple data collectors within the venue and, at 208, the data accumulator uploads the data to a master database. For example, to mitigate an amount of network traffic in the venue, each data accumulator may be programmed to transmit its data while the event is closed or at non-busy times. The timing of the transmission may be similar to the timing discussed above with respect to the data collectors. However, the data accumulator waits until data from its associated data collectors is received before transmitting its information to the master database.

The master database may be located in the “cloud.” Alternatively or additionally, the master database may be a trusted third party server that is configured to retain data. The data collector may upload the information continuously (e.g., in real-time or live), periodically, at random intervals, based upon a trigger event, based upon an amount of data collected, or at other times. According to an implementation, the information is uploaded to the data accumulator once a day, every other day, at the conclusion of the event, and so forth.

At 210, the data retained in the master database is transformed to a business intelligence database. According to some implementations, the data accumulator uploads the information directly to the business intelligence database, bypassing the master database.

The business intelligence database and associated functionality makes data available, at 212. The data made available may be provided to vendors at the event or to others for marketing and data analysis purposes. For example, the data available may be provided as reports, spreadsheets, summaries, or other formats. According to some implementations, the data is provided to the vendors during the event (e.g., data from yesterday is provided today) or after the event. Further, the reports provided are configurable such that the vendors may manipulate the data based on marketing strategy or other considerations.

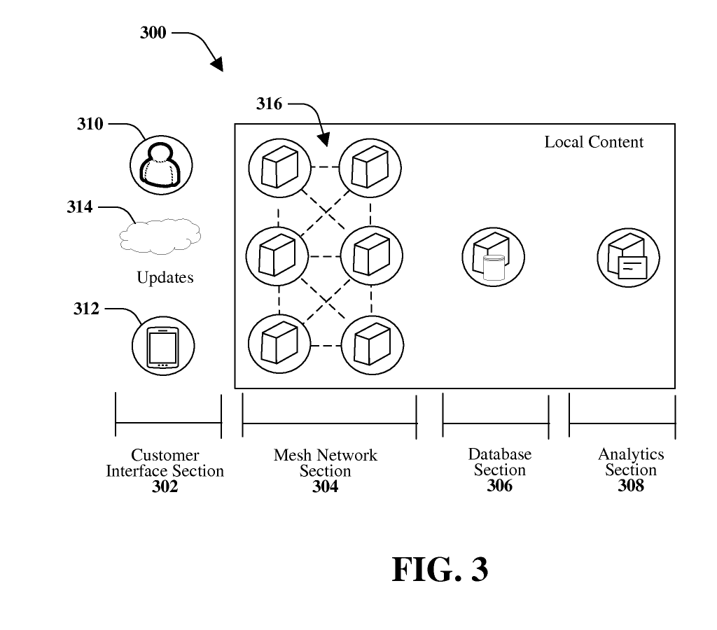

FIG. 3 illustrates an example, non-limiting representation of a high-level architecture 300, according to an aspect. The architecture 300 includes various sections, labeled as a customer interface section 302, a mesh network section 304, a database section 306, and an analytics section 308.

The customer interface section 302 includes various interactions with the customer (e.g., target entity). For example, the customer interface section 302 includes a UUID 310, such as the wearable UUID 106 of FIG. 1. Also included is a mobile application (e.g., the web application 102 of FIG. 1) and a web application program interface (API), which may be associated with a mobile device 312 (e.g., the mobile device 104 of FIG. 1). The mobile application may be configured to request data from the data acquisition and analytics reporting system. However, the mobile application does not request specific content, instead, the mobile application simply asks for the most recent content. The system will respond with the most recent content that is associated with a current position of the attendee as determined by the information from the wearable UUID (e.g., location aware content). The web API may include a set of routines, protocols, and tools for software applications.

Further, the customer interface section 302 may include ad-hoc transactional updates 314. For example, when information needs to be updated, the updates may be dynamically applied and, when the attendee requests information, the updated information is automatically output to the attendee. In such a manner, the attendee is provided the most current data available related to the subject of interest at the booth where the attendee is located.

The mesh network section 304 may include a set of UUID transceivers 316 that are connected in a mesh topology (illustrated by the dashed lines). The UUID transceivers 316 communicate with each other and may operate as back up for each other (e.g., provide redundant services). Each UUID transceiver of the set of UUID transceivers may be associated with a respective location in the venue. For example, the location may be booth at an exposition, a fair, an auto show, a brick and mortar store, and so forth. Further, depending on the size of the location (e.g., the geographic footprint of the booth), there may be more than (or fewer than) six UUID transceivers in each set.

The database section 306 may be configured to receive synchronized information. Such information may include content and activities associated with the user that carries the UUID 310. Further, the analytics section 308 may be configured to performing reporting and data analysis.

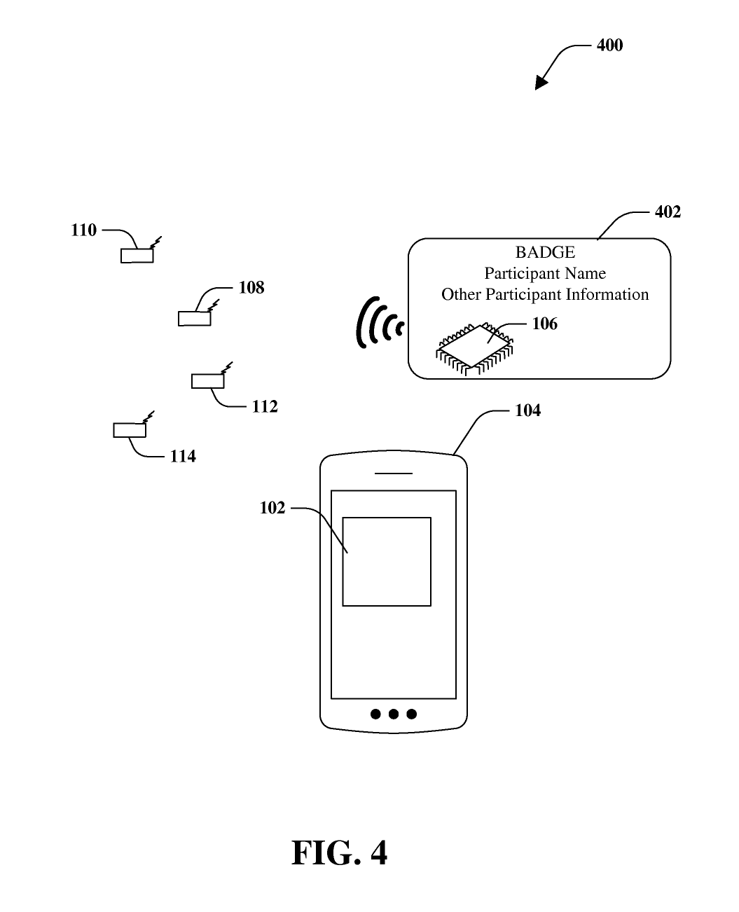

FIG. 4 illustrates a user-portion 400 of the non-limiting system 100 of FIG. 1 for data acquisition and analytics reporting, according to an aspect. The mobile application 102 may provide event participants with location-aware content. This content may be served by a local Wi-Fi access point provided by the UUID data collectors set up throughout the facility (e.g., venue).

Thus, as the user walks up to a specific items (e.g., exhibits, demonstrations, objects) in the event, for example a car, and if using the mobile application, the user may receive information regarding that specific car. This information may include, but is not limited to, images, video, specifications, pricing and financing information, local dealership contact information, and so forth. If the user indicates they like the vehicle, the user is provided the ability to save the information for post-event viewing. For example, the user may interface with the application to indicate they like the vehicle, such as by responding yes” or “no” to a prompt asking if they like the vehicle.

When the mobile application requests data, it does not request specific content. Instead, the mobile application merely requests “current” content for a specific wearable UUID identifier. Thus, when a user is next to object A, the reader installed in object A will receive the UUID signal and incorporate that information into the system. Thereafter, when the user requests “current content,” object A information will be transmitted. Subsequently, when the user moves to object B, and the system processes that change, “current content” requests may now result in object B information being transmitted.

Each event participant may be fitted with a small battery-powered wearable device 106 that may include a chip, such as an RFID chip, for example. The wearable device 106 may be housed in a badge 402 or in another item that may be easily carried by the user. For example, the credentials of a person attending the event may have an RFID inlay. The wearable device 106 may be configured to broadcast a unique identifying signal at a predefined rate, for example. Various types of wearable devices 106 may be utilized with the disclosed aspects. The consideration of a particular wearable device may be determined based on availability, price per unit, power requirements, size limitations, and maintainability. According to some implementations, Bluetooth Low Energy (LE) (4.0) chips may be utilized with one or more aspects.

Each chip may be programmed to send an iBeacon compatible signal, for example. According to an implementation, each signal may contain a universally unique identifier (UUID), a major identifier, and a minor identifier. For example, the UUID may be a 16-byte UUID, the major identifier may be a 2 byte major identifier, and the minor identifier may be a 2 byte minor identifier.

The UUID is a unique identifier that allows the system to differentiate between UUIDs utilized for the data acquisition and analytics reporting system and other iBeacons that might be utilized in the facility. The major and minor identifiers define the specific chip. The 4 byte combination of identifiers allows for 2, 147, 483, and 647 unique values. However, a different number of units of digital information (bytes) may be utilized.

According to some implementations, the wearable device 106 may be utilized after the event and the UUID data collectors may installed at a store. In one example, a person attended a country music festival and purchased a belt at a booth during the festival. Thereafter, the person visits a store that hosted the booth (e.g., to use a discount coupon, to browse more items offered by the vendor, and so forth). Based on the information provided by the wearable device 106 (as read by the one or more UUID transceivers installed in the store), a sales associate may know (e.g., through an application accessible by the sales associate) that the person purchased the belt at the event and might offer to show her a pair of boots that match the belt. Thus, tailored advertisements and targeted marketing may be employed based on the activities of the event attendee.

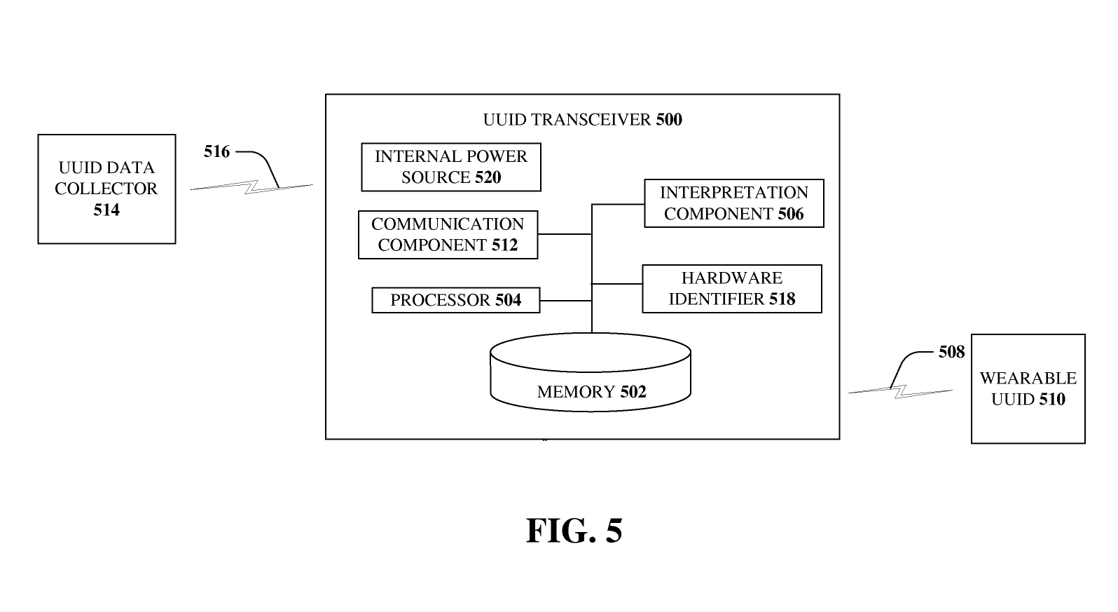

FIG. 5 illustrates a UUID transceiver 500 that may be included in a mesh network portion of the non-limiting system 100 of FIG. 1 for data acquisition and analytics reporting, according to an aspect. The UUID transceiver 500 may include at least one memory 502 that may store computer executable components and/or computer executable instructions. The UUID transceiver 500 may also include at least one processor 504, communicatively coupled to the at least one memory 502. The at least one processor 504 may facilitate execution of the computer executable components and/or the computer executable instructions stored in the memory 502. The term “coupled” or variants thereof may include various communications including, but not limited to, direct communications, indirect communications, wired communications, and/or wireless communications.

It is noted that although the one or more computer executable components and/or computer executable instructions may be illustrated and described herein as components and/or instructions separate from the memory 502 (e.g., operatively connected to the memory 502), the various aspects are not limited to this implementation. Instead, in accordance with various implementations, the one or more computer executable components and/or the one or more computer executable instructions may be stored in (or integrated within) the memory 502. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple components and/or as multiple instructions without departing from the example embodiments.

The UUID transceiver 500 may also include an interpretation component 506 that may be configured to read a signal 508 received from at least one wearable UUID 510 (e.g., the wearable UUID 106 of FIG. 1). For example, the interpretation component 506 may distinguish the signal 508 from other signals that are being transmitted within the venue. According to some implementations, the interpretation component 510 may be configured to decode at least a set of information include in the signal 508. The interpretation component 506 may also be configured to attempt to discover unauthorized devices and prevent the unauthorized devices from sending information into the network based at least in part on information included in the signal 508.

Also included in the UUID transceiver 500 may be a communication component 512 that may be configured to send the information read by the interpretation component 506 to an associated UUID data collector 514 (e.g., the UUID data collector 116 of FIG. 1). The communication component 512 may also include logic to filter the signals, or schedule the signals, in order to reduce the amount of traffic on the network.

The message from the transceivers to the data collector may be transmitted over various networks, illustrated by wireless data link 516. For example, the message may be transmitted over an open, global wireless standard (e.g., a Zigbee wireless network based on the IEEE 802.15.4 standard). An open, global wireless standard may provide an ad-hoc mesh network, which may allow a longer range between the transceiver and the collector, provided there are intermediary devices available to relay the messages. The message structure may be a common structure, or may be custom based on the amount of privacy desired when conveying the messages.

The UUID transceiver 500 may be programmed with a hardware identifier 518. The hardware identifier 518 may be unique to each event, although the UUID transceiver 500 may be reused at different events. Further, the hardware identifier 518 may be set in an operations portal prior to deployment. When a system for data acquisition and analytics reporting is initially being set up at the venue, the UUID transceiver 500 may be configured to look for UUID data collector devices in its wireless communications range. The UUID data collector device will respond, registering the UUID transceiver 500 and providing the UUID transceiver 500 with the current network time. In this way, any non-predefined UUID transceivers will not be able to register in the mesh network.

Further, the UUID transceiver 500 may include an internal power source 520. For example, the internal power source 520 may include batteries, a battery pack, or another manner of generating power (e.g., solar power generation). Alternatively or additionally, the UUID transceiver 500 may utilize an external power source, if available.

The UUID transceiver 500 may execute a code configured to read Bluetooth LE signals from a module, for example. The module may be configured to listen to the complete Bluetooth LE band, however the chipset might not have a large enough buffer to process the entire message. Thus, the UUID payload available for this module may be limited to a determined number of bytes after the protocol requirements are fulfilled.

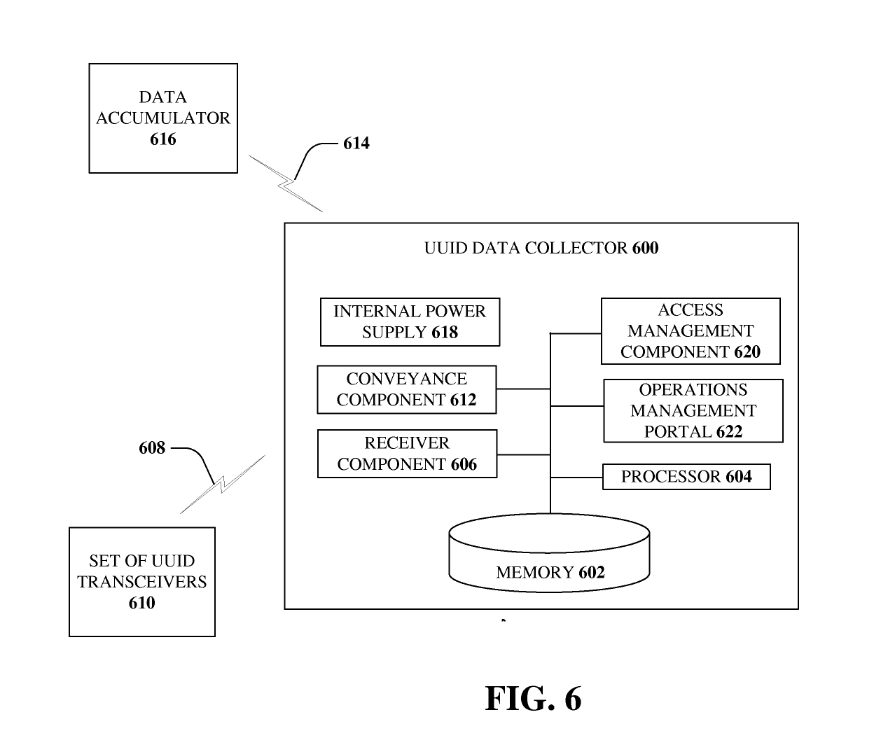

FIG. 6 illustrates a UUID data collector 600 that may be included in a database portion of the non-limiting system 100 of FIG. 1 for data acquisition and analytics reporting, according to an aspect. The UUID data collector 600 may include at least one memory 602 that may store computer executable components and/or computer executable instructions. The UUID data collector 600 may also include at least one processor 604, communicatively coupled to the at least one memory 602. The at least one processor 604 may facilitate execution of the computer executable components and/or the computer executable instructions stored in the memory 602.

The UUID data collector 600 may also include a receiver component 606 that may be configured to obtain UUID data 608 from a defined set of UUID transmitters 610. As used herein the term “set,” “subset,” or the like excludes the empty set (e.g., the set with no elements therein). Thus, a “set,” “subset,” or the like includes one or more elements or devices. As an illustration, a set of UUID transmitters includes one or more UUID transmitters; a set of UUID data collectors includes one or more UUID data collectors; and so forth. In a similar manner, the term “group” as utilized herein refers to a collection of one or more entities. For example, a group of nodes refers to one or more nodes.

The UUID data collector 600 may also include a conveyance component 612 that may be configured to convey at least a set of the obtained UUID data 614 to a data accumulator 616 (e.g., the data accumulator 118 of FIG. 1). The conveyance component 612 may be configured to parse the messages from each UUID transceiver of the set of UUID transceivers 610 (e.g., readers). The resulting data may be inserted (e.g., stored) into an internal database, which may be the memory 602 or another type of storage media. According to an implementation, the database may be an internal MySQL database; however, the disclosed aspects are not limited to this implementation.

The information in the database (e.g., the memory 602) may be extracted and sent to the data accumulator 616 (e.g., data aggregator) by the conveyance component 612. The data may be sent continuously (e.g., in real-time), periodically, at defined intervals, based on a trigger event, or at another time). The data accumulator 616 may be configured to capture the data from the UUID data collector 600 and the other UUID data collectors at the venue. The collected data is transmitted or uploaded to a business intelligence database (not shown). The transmission may be over the internet, for example. Further, the business intelligence database may be stored on off-site servers (e.g., in the cloud).

The UUID data collector 600 may be powered by an internal power supply 618. For example, the internal power supply 618 may be one or more batteries, a battery pack (e.g., a 5 volt battery pack), or another type of power source. Alternatively or additionally, the UUID data collector 600 may be powered by an external power source, such as an 110v AC circuit.

Also included in the UUID data collector 600 is an access management component 620 that may be configured to provide content and network access to mobile devices (not shown) within range of the UUID data collector 600. According to an implementation, the network access may be Wi-Fi LAN network access. However, another type of network access may be utilized with the disclosed aspects.

There may be a custom personal home page (PHP) web application, hosted on a server (such as free hosting server), which provides a RESTful API for CRUD operations on the MySQL database. Additionally or alternatively, there may be http content provided to the mobile applications. The PHP web application may query the MySQL database for the most recent location that the system is aware of for the specified wearable UUID ID, translates it to the associated content, and responds by sending that content.

In addition, the UUID data collector 600 may be programmed with an identifier, which may be configured by an operations portal, according to an aspect. At setup, each UUID data collector communicates with its assigned master device (e.g., the data accumulator 616), and is registered on the network. If the UUID data collector ID does not match the configured id, then it is not registered and the activity is logged for security and or operations teams to investigate. Once the UUID data collector is registered, the UUID data collector enters a setup mode, listening for its associated set of UUID transceivers 610 to come online.

The data accumulator 616, or master device, may be the central node of the network, and might be the only device with an internet connection if available. All UUID data collector devices send their data to the data accumulator 616, and the data accumulator 616 device may upload the information to the internet.

The data accumulator 616 may contain all the network configuration keys and content for the event, which may be predefined by the operations portal. The data accumulator 616 also manages and hosts an operational data status database. Therefore, the physical security of the data accumulator 616 should be protected. According to some implementations, a router (e.g., a secondary router) may be configured to communicate the information from the data accumulator 616 to the internet, providing a level of security for the data accumulator 616.

The gathered information may be processed by a business intelligence system, which may include various databases. For example, the databases may be a transactional database, an analytics database, a data warehouse database, or another database.

The transactional database may be used during the event to provide “live” dashboard data, which may be output on the mobile device. The transactional database might only contain the data (and be tuned) for ongoing events.

The analytics database may be a replica of the transactional database, but may contain data for historical events. The analytics database may not always be completely current however, since data loads from the transactional database will need to take place to update the analytics database.

The data warehouse database is an online analytical processing (OLAP) database that may be specifically tuned to provide more performant data analytics and data mining. The data warehouse database may contain historical, aggregated data stored in multi-dimensional schemas.

A reporting portion is proved and might be an open source server-side Web application framework (e.g., an ASP.NET web application). The reporting portion reports on development hardware. There may be a number of individual reports, wherein each report obtains data from the transactional database instance. Such reports may include, but are not limited to actionable sales data, event activity, showroom activity, and so forth.

The UUID data collector 600 may host an operations management portal 622, which may be only accessible by authorized individuals. The operations management portal 622 may be used to define the hardware and network topology of all deployed data acquisition and analytics reporting systems for events. Prior to the event, the data accumulator 616 should be updated with the expected topology and configured hardware devices in the system.

The operations management portal 622 may allow for various values to be managed and downloaded to the data accumulator 616 for setup at the event. For example, values related to the data accumulator 616 (e.g., master device) may include, but are not limited to, an event identifier, a host IP address, a SSID, a list of assigned UUID data collector devices, mobile data content, and so forth. In another example, values related to the one or more UUID data collectors may include, but are not limited to, UUID data collector identifier, parent event identifier, list of assigned UUID transmitter identifiers, mobile data content, and others. In a further example, values related to UUID transceivers may include, but are not limited to, UUID transceiver identifiers, parent UUID transceiver identifier, and others.

According to various aspects an operations management status system may be provided. The operations management system is an application and web portal that may define event hardware installations, provide a tracking mechanism for the installation and teardown of the associated hardware, and provide real-time feedback on the operational status of the deployed systems during the event. There may be screen or displays configured to output information related to network/event level status, booth level status, and/or area level status.

On each screen, a universal color-coding scheme may be used to indicate the current status at that level of visibility. For example, a green color may indicate the current hardware and all associated sub systems are running as expected. A red color may indicate the current hardware or at least one sub system is reporting an error. A blue color may indicate that operations staff are currently actively working on the hardware. Further to this example, a gray color may indicate the current hardware or at least one sub system is not installed. However, it should be understood that other color schemes and/or data indicators may be utilized with the disclosed aspects.

The event level status screen may provide a status overview of every booth in the event space. Each color-coded status indicator may represent one booth running the data acquisition and analytics reporting system. There may also be a text field for the operations team to indicate any current activity at the event level.

In operation, if any system devices in that booth are currently reporting that it is communicating to the master and all defined subsystems are similarly running as expected, the status indicator will be green. If any devices in that booth are currently reporting an error, the status indicator will be red. If the operations team has indicated they are currently and actively working on the UUID data collector or any subsystems, the status indicator will be blue. If the operations team has yet to turn on a UUID data collector or any subsystem (setup), or have turned off and packed a UUID data collector or any subsystem (teardown), the status indicator will be gray. However, it should be understood that other color schemes and/or data indicators may be utilized with the disclosed aspects.

The booth level status screen may provide an overview of each system device in that particular booth. Each color-coded status indicator may represent one system device running in the specified booth. There may also be a text field for the operations team to indicate any current activity at the booth level.

In an operation example, if all micro devices assigned to that UUID data collector are currently responding to heartbeat messages and indicating successful status, the status indicator will be green. If any micro devices assigned to that UUID data collector are currently reporting an error, the status indicator will be red. If the operations team has indicated they are currently and actively working on that particular UUID data collector or a UUID transreceiver assigned to that UUID data collector, the status indicator will be blue. If the operations team has yet to turn that particular UUID data collector or any UUID transreceiver (e.g., micro device) assigned (setup), or have turned off and packed that particular UUID data collector or any micro device assigned (teardown), the status indicator will be gray. However, it should be understood that other color schemes and/or data indicators may be utilized with the disclosed aspects.

The area level status screen may provide an overview of each micro device assigned to a specified area. Each color coded status indicator represents one UUID transceiver (e.g., micro device) assigned to the specified UUID data collector device. There may also be a text field for the operations team to indicate any current activity at the area level. The operations team may also have the option to load all prior event activity records to investigate an issue.

In an operation example, if the current micro device receives a heartbeat message, and its internal status is good, the status indicator will be green. If the current micro device knows of an internal error status (for example low battery), the status indicator will be red. If the operations team has indicated they are currently and actively working on the particular micro device, the status indicator will be blue. If the operations team has yet to turn that particular micro device (setup), or have turned off and packed that particular micro device (teardown), the status indicator will be gray.

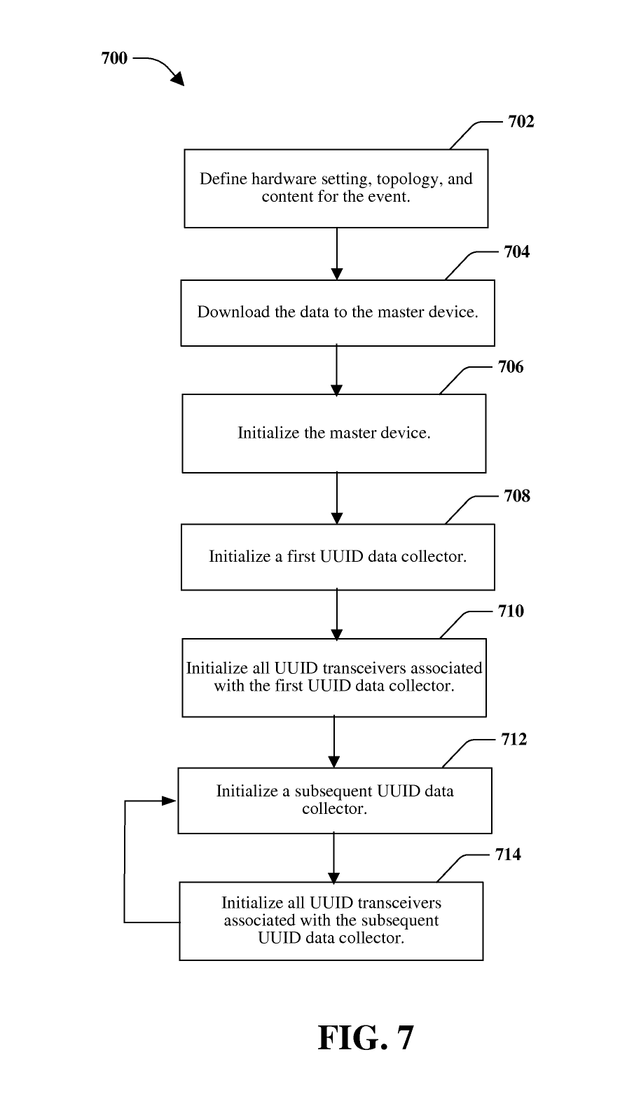

FIG. 7 illustrates an example, non-limiting method for deploying a data acquisition and analytics reporting system, according to an aspect. At 702, the hardware settings, topology, and content for the event is defined in the portal. Then, at 704, the data is downloaded to the master device (e.g., the data accumulator 118 of FIG. 1) and the master device is initialized, at 706. The operations application will show gray statuses (if using the above described color-scheme) for all booths in the system (e.g., at the venue).

At 708, the first UUID data collection device (e.g., the UUID data collection device 116 of FIG. 1) is initialized. The operations application will show a blue status (if using the above described color-scheme) for the booth that uses the first UUID data collection device.

At 710, all UUID transceivers (e.g., micro) for the booth are initialized. As each UUID transceiver is initialized or comes online, the operations application will show a green status for that UUID transceiver. At about the same time as all defined UUID transceivers are online and communicating, the UUID data collector device status will turn green. If all UUID data collector applications are initialized, the status for this particular booth will turn green.

The method 700 may continue, at 712, and a subsequent UUID data collector device for a subsequent booth is initialized. The operations application will show a blue status (if using the above described color-scheme) for the booth that uses the subsequent UUID data collection device.

Further, at 714, all UUID transceivers for the subsequent booth are initialized. As each UUID transceiver for the subsequent booth is initialized or comes online, the operations application will show a green status for that UUID transceiver. At about the same time as all defined UUID transceivers are online and communicating, the subsequent UUID data collector device status will turn green. If all UUID data collector applications are initialized, the status for the communicating booth will turn green.

The method 700 may continue, at 712, for a next (e.g., subsequent) booth. It is to be understood that the initialization of a next UUID data collector, at 712, and the UUID transceivers for the subsequent booth, at 714, may be recursive. For example, any number of booths may be initialized and brought online until all booths and associated devices are brought online and operating correctly.

During the event, if any micro device, UUID data collector, or master device indicates a failure, the indicator status for the device will turn red. For example, if the micro device determines its battery level is low, it will send that message to the system. The operations application for that booth will indicate red for an error condition. The operations team may click on an indicator for the booth, to drill down to the list of UUID data collectors and one of them will indicate red for an error condition. The operations team may click on the UUID data collector to drill down to the list of micros and one of them will indicate red with a low battery message. The operations team may then indicate they are replacing the battery. For example, the operations team may type in the application that they are replacing the battery. All red status indicators in this scenario will turn blue. Once the battery is replaced, all status indicators in the scenario will turn green. Each activity message is stored by the system and uploaded to the business intelligence database as appropriate.

After the event, it may be assumed that all indicators are working and are green (no problems detected). At the first teardown booth, as each micro is turned off, the UUID data collector and event level indicators turn blue. As the last assigned micro for a UUID data collector is turned off, and the UUID data collector indicator will turn gray. As the last assigned UUID data collector is turned off, the booth indicator will turn gray. Once all indicators in the system are gray, it indicates that all hardware has been successfully recovered.

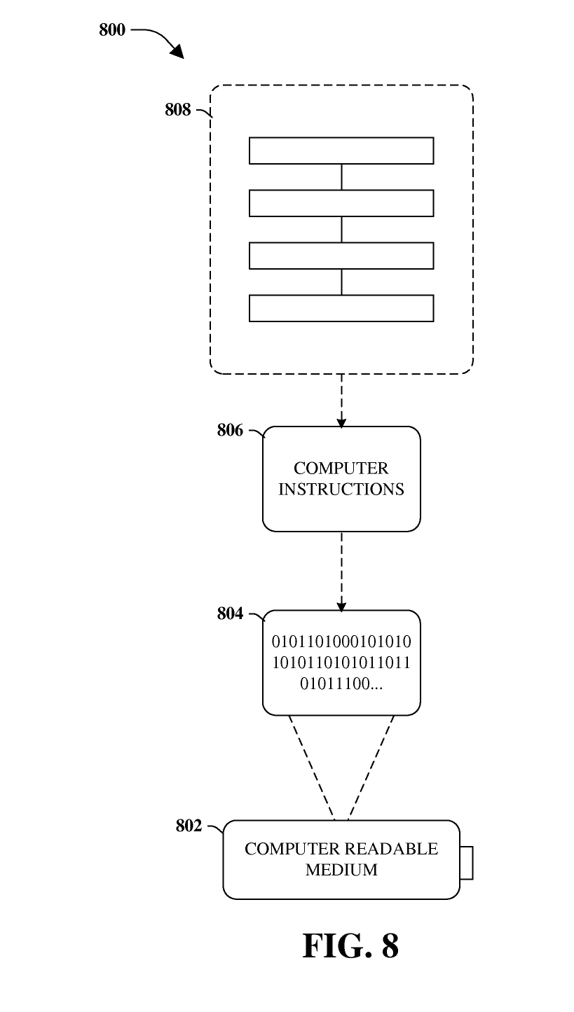

One or more implementations include a computer-readable medium including processor-executable instructions configured to implement one or more embodiments presented herein. An embodiment of a computer-readable medium or a computer-readable device devised in these ways is illustrated in FIG. 8, wherein an implementation 800 includes a computer-readable medium 802, such as a CD-R, DVD-R, flash drive, a platter of a hard disk drive, and so forth, on which is encoded computer-readable data 804. The computer-readable data 804, such as binary data including a plurality of zero's and one's as illustrated, in turn includes a set of computer instructions 806 configured to operate according to one or more of the principles set forth herein.

In the illustrated embodiment 800, the processor-executable computer instructions 806 may be configured to perform a method 808, such as the method 200 of FIG. 2, for example. In another embodiment, the processor-executable instructions 804 may be configured to implement a system, such as the system 500 of FIG. 5 and/or the system 600 of FIG. 6, for example. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

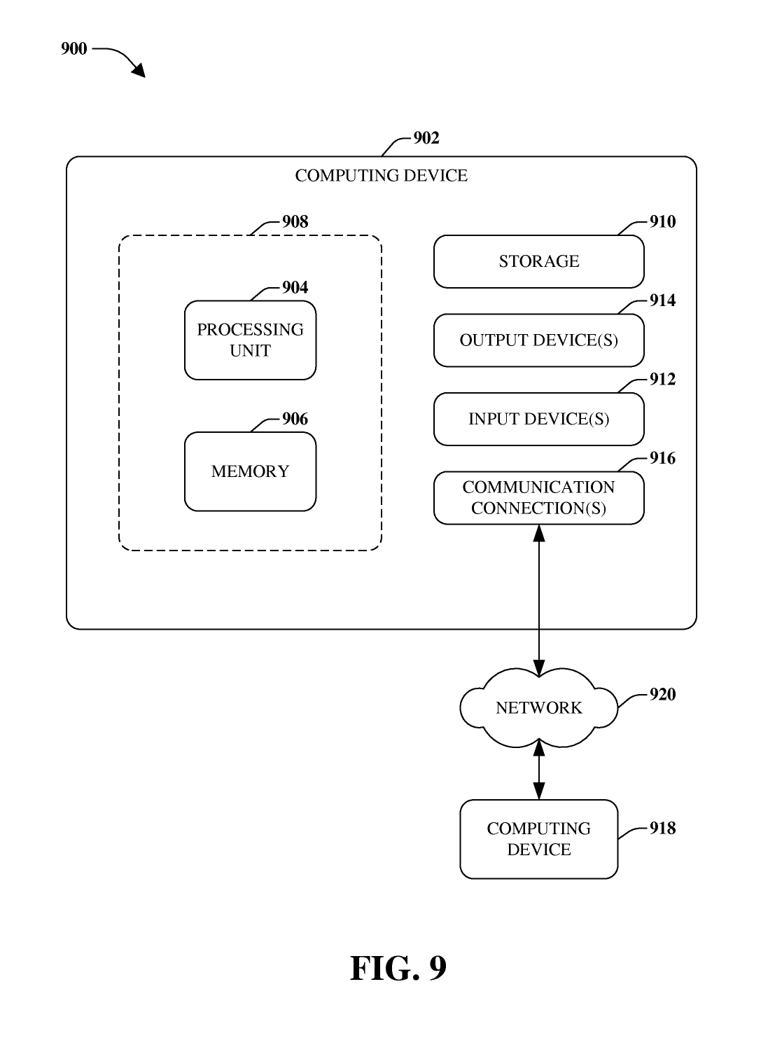

FIG. 9 and the following discussion provide a description of a suitable computing environment to implement embodiments of one or more of the aspects set forth herein. The operating environment of FIG. 9 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 9 illustrates a system 900 that may include a computing device 902 configured to implement one or more embodiments provided herein. In one configuration, the computing device 902 may include at least one processing unit 904 and at least one memory 906. Depending on the exact configuration and type of computing device, the at least one memory 906 may be volatile, such as RAM, non-volatile, such as ROM, flash memory, etc., or a combination thereof. This configuration is illustrated in FIG. 9 by dashed line 908.

In other embodiments, the device 902 may include additional features or functionality. For example, the device 902 may include additional storage such as removable storage or non-removable storage, including, but not limited to, magnetic storage, optical storage, etc. Such additional storage is illustrated in FIG. 9 by storage 910. In one or more embodiments, computer readable instructions to implement one or more embodiments provided herein are in the storage 910. The storage 910 may store other computer readable instructions to implement an operating system, an application program, etc. Computer readable instructions may be loaded in the at least one memory 906 for execution by the at least one processing unit 904, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The device 902 may include input device(s) 912 such as keyboard, mouse, pen, voice input device, touch input device, infrared cameras, video input devices, or any other input device. Output device(s) 914 such as one or more displays, speakers, printers, or any other output device may be included with the device 902. The input device(s) 912 and the output device(s) 914 may be connected to the device 902 via a wired connection, wireless connection, or any combination thereof. In one or more embodiments, an input device or an output device from another computing device may be used as the input device(s) 912 and/or the output device(s) 914 for the device 902. Further, the device 902 may include communication connection(s) 916 to facilitate communications with one or more other devices, illustrated as a computing device 918 coupled over a network 920.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system, comprising:
a universally unique identifier transceiver that receives data from a wearable device based on the wearable device being brought into a communication range of the universally unique identifier transceiver, wherein the wearable device is associated with a target entity at a live event;
a universally unique identifier data collector that receives a set of the data from the universally unique identifier transceiver and another set of data from at least another universally unique identifier transceiver, wherein the universally unique identifier transceiver and the other universally unique identifier transceiver are predefined for the universally unique identifier data collector; and
a data accumulator that obtains the set of the data and the other set of data from the universally unique identifier data collector and at least one other universally unique identifier data collector at a time selected to mitigate an amount of network traffic at the live event, wherein the set of the data and the other set of data are included in a strategic marketing campaign based on the live event.

2. The system of claim 1, wherein the wearable device operates as a reverse universally unique identifier that broadcasts information associated with an identity of the target entity.

3. The system of claim 1, wherein the universally unique identifier data collector and at least the other universally unique identifier data collector form a mesh network.

4. The system of claim 3, wherein the universally unique identifier data collector operates as a back-up data collector for at least the other universally unique identifier data collector.

5. The system of claim 1, wherein the universally unique identifier data collector responds to a request for recent content received from a mobile application, wherein the mobile application includes a reference to an identification of the wearable device.

6. The system of claim 5, wherein the universally unique identifier data collector provides the recent content based on a location of the wearable device.

7. The system of claim 1, wherein the universally unique identifier transceiver conveys the set of data to the universally unique identifier data collector at another time selected to mitigate the amount of network traffic at the live event.

8. The system of claim 1, wherein the data accumulator sends the obtained gathered communication to an external node.

9. The system of claim 8, wherein the external node is located in the cloud and comprises a SQL database.

10. The system of claim 8, wherein the data accumulator sends the obtained gathered communication to a secondary router that conveys the communication to the external node.

11. The system of claim 1, wherein the universally unique identifier transceiver and the universally unique identifier data collector are self-powered.

12. A method, comprising:
receiving, at a first device, data from a universally unique identifier associated with an attendee at an event comprising detecting the universally unique identifier is within a wireless communications range of the first device;
outputting, by the first device to a mobile application associated with the universally unique identifier, dynamic electronic information associated with a current location of the universally unique identifier;
conveying, by the first device, the received data to a second device at a time selected to mitigate an amount of wireless data traffic within the event;
temporarily storing, by the second device, the received data;
transmitting, by the second device, the temporarily stored data to a third device at a time selected to mitigate another amount of the wireless data traffic within the event; and
communicating, by the third device, at least a set of the stored data to an external database.

13. The method of claim 12, further comprising:
receiving, at a fourth device, a set of data from the universally unique identifier when the universally unique identifier is within a wireless communications range of the fourth device;
outputting, by the fourth device to the mobile application associated with the universally unique identifier, dynamic electronic information associated with the current location of the universally unique identifier;
conveying, by the fourth device, the set of data to the second device at the time selected to mitigate the amount of wireless data traffic within the event;
temporarily storing, by the second device, the set of data;
transmitting, by the second device, the set of data to the third device at the time selected to mitigate another amount of the wireless data traffic within the event; and
communicating, by the third device, the set of data to an external database.

14. The method of claim 13, wherein the communicating the set of data to an external database comprises aggregating the set of the stored data and the set of data and sending the aggregated data to the external database.

15. The method of claim 13, further comprises forming a mesh network that includes the second device and at least a fifth device, wherein the fifth device operates as a back-up device for the second device.

16. The method of claim 12, further comprising:
aggregating the set of the stored data with another set of stored data;
determining one or more marketing opportunities based on the aggregated data; and
outputting the one or more marketing opportunities to a vender associated with the first device or the second device.

17. The method of claim 12, wherein the first device and the second device are self-powered devices.

18. The method of claim 12, further comprising outputting respective status indicators associated with the first device, the second device, and the third device, wherein the respective status indicators convey information related to respective operational statuses of the first device, the second device, and the third device.

19. A computer-readable storage device storing executable instructions that, in response to execution, cause a system comprising a processor to perform operations, comprising:
determining a location of an attendee at a live event;
outputting information related to a display associated with the location of the attendee based on a request for the information;
compiling information indicative of the attendee and the request with other information indicative of other attendees and other requests; and
dynamically creating at least one report based on an analysis of the complied information.

20. The computer-readable storage device of claim 19, wherein the outputting the information comprises outputting the information at a time selected to mitigate an amount of data network traffic occurring at the live event.
